(19) United States
(12) Patent Application Publication
(10) Pub. No.: US 2025/0097859 A1
(43) Pub. Date: Mar. 20, 2025

(54) REPORTING OF A PARAMETER FOR ADJUSTMENTS TO A MAXIMUM OUTPUT POWER FOR A GIVEN POWER CLASS

(71) Applicant: ZTE CORPORATION, Shenzhen (CN)

(72) Inventors: Jing SHI, Shenzhen (CN); Xianghui HAN, Shenzhen (CN)

(73) Assignee: ZTE CORPORATION, Shenzhen (CN)

(21) Appl. No.: 18/967,284

(22) Filed: Dec. 3, 2024

Related U.S. Application Data
(63) Continuation of application No. PCT/CN2023/111319, filed on Aug. 4, 2023.

(51) Int. Cl. H04W 52/36

(52) U.S. Cl. CPC H04W 52/367; H04W 52/365

(57) ABSTRACT

A power headroom report (PHR) includes reporting of a parameter for adjustment to a maximum output power for a given power class. The parameter is determined by user equipment (UE) based on evaluation of a duty cycle and reported when triggered by a duty cycle being exceeded with a new event or based an expiration of a timer for a legacy event. The parameter may be ΔPPowerClass which is reported and used for realizing a high-power uplink transmission.

### TECHNICAL FIELD

This document is directed generally to wireless communications. More specifically, there may be enhancements to a power headroom report (PHR) including reporting of a parameter for adjustment to a maximum output power for a given power class.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

In wireless communication, a user equipment (UE) may have capability to support one or more different power class than the default UE power class for the band and the supported power class enables the higher maximum output power than that of the default power class. When a percentage of uplink symbols transmitted in a certain evaluation period (e.g., duty cycle) is larger than a threshold (e.g., maximum duty cycle), the UE may apply all requirements for the default power class to the supported power class. There are various issues/problems associated with this implementation. For example, one issue/problem may be that, while the evaluation period is no less than one radio frame, a base station may not know the exact evaluation period that the UE used and also not know the duration of default power class applied, which may lead to some ambiguity issue for uplink power control.

### SUMMARY

This document relates to methods, systems, and devices for wireless communications including a power headroom report (PHR) that includes reporting of a parameter for adjustment to a maximum output power for a given power class. The parameter is determined by user equipment (UE) based on evaluation of a duty cycle and reported when triggered by a duty cycle being exceeded with a new event or based an expiration of a timer for a legacy event. The parameter may be ΔP_{PowerClass} which is reported and used for realizing a high-power uplink transmission.

In one embodiment, a method for wireless communication includes determining, by a device, a parameter of adjustment to maximum output power for a given power class based on evaluation of a duty cycle; and reporting the parameter when triggered by one or more events, the one or more events comprise a duty cycle being exceeded for a first new event, or an expiration of a timer for a legacy event.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows an embodiment of a wireless network system architecture.

FIG. 4A illustrates one example of a power headroom report (PHR) structure.

FIG. 4B illustrates another example of a PHR structure with a parameter for adjustment to a maximum output power for a given power class.

FIG. 4C illustrates another example of a PHR structure with a parameter for adjustment to a maximum output power for a given power class.

FIG. 5 illustrates timing for a PC2 band example.

FIG. 6 illustrates timing for a PC1.5 band example.

FIG. 7 illustrates timing for another PC1.5 band example.

FIG. 8 illustrates timing for a band example where duration of PC fallback does not equal the evaluation period.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

Radio resource control (“RRC”) is a protocol layer between UE and the basestation at the Internet Protocol (IP) level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

Wireless or mobile communication technology improvements result in increased demands. Based on the current development trend, systems are developing support on features of enhanced mobile broadband (eMBB), ultra-reliable low-latency communication (URLLC), and massive machine-type communication (mMTC). Full duplex may be a requirement for 5G and subsequent communication systems. In wireless communication, a network device, such as a user equipment (UE), may perform uplink (UL) transmitter (Tx) switching between bands. For multi-carrier operation, a network device that transmits with two transmitters (also called a 2Tx user device), may transmit in two UL bands. Which two bands that are used may be changed by radio resource control (RRC) reconfiguration.

In wireless communication system, a user equipment (UE) may have capability to support one or more different power class than the default UE power class for the band and the supported power class enables the higher maximum output power than that of the default power class. When a percentage of uplink symbols transmitted in a certain evaluation period (e.g., duty cycle) is larger than a threshold (e.g., maximum duty cycle), the UE may apply all requirements for the default power class to the supported power class. There are various issues/problems associated with this implementation. For example, one issue/problem may be that, while the evaluation period is no less than one radio frame, a base station (or a wireless communication node) may not know the exact evaluation period that the UE used and also not know the duration of default power class applied, which may lead to some ambiguity issue for uplink power control. Another issue/problem may include that, in case non-overlapped sub-band full duplex is applied wherein a uplink sub-band is introduced in downlink or flexible symbols, it is uncertain how to calculate the percentage of uplink symbols transmitted in a certain evaluation period. The present disclosure describes various embodiments for reporting a parameter for adjustment to a maximum output power for a given power class, addressing at least one of the issues/problems discussed in the present disclosure.

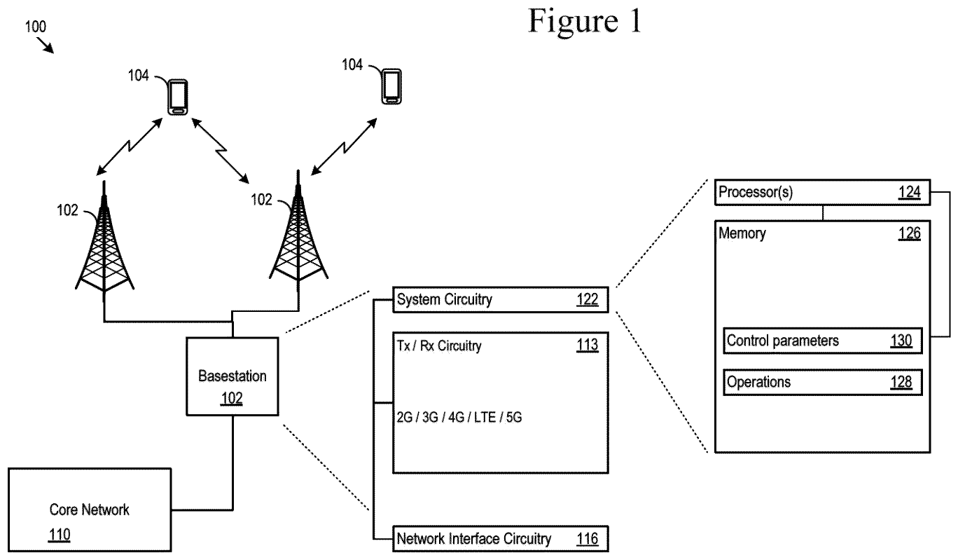

FIG. 1 shows an example basestation 102. The basestation may also be referred to as a network device or wireless network node. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals. Also, particular signals can be characterized or defined as either an uplink (UL) signal, a downlink (DL) signal, or a sidelink (SL) signal. An uplink signal is a signal transmitted from a UE 104 to a basestation 102. A downlink signal is a signal transmitted from a basestation 102 to a UE 104. A sidelink signal is a signal transmitted from one UE 104 to another UE 104.

For at least some specifications, such as 5G New Radio (NR), data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a basestation 102 to a UE 104. In other embodiments, the control information includes uplink control information (UCI) that is transmitted in the uplink direction from a UE 104 to a basestation 102, or sidelink control information (SCI) that is transmitted in the sidelink direction from one UE 104 to another UE 104.

In addition, in some embodiments, a UE 104 may be configured to support at least one simultaneous UL transmission mode across a band pair for UL transmissions. In a first simultaneous UL transmission mode (also called a switchedUL mode), the UE 104 does not support simultaneous UL transmission across a band pair. Accordingly, when the UE 104 transmits an UL transmission in the first simultaneous UL transmission mode, the UE 104 transmits the UL transmission without simultaneously transmitting across a band pair. In addition, in a second simultaneous UL transmission mode (also called a dualUL mode), the UE 104 supports simultaneous UL transmission across a band pair. Accordingly, when the UE 104 transmits an UL transmission in the second simultaneous UL transmission mode, the UE 104 may transmit the UL transmission by simultaneously transmitting across a band pair.

Also, in some embodiments, the UE 104 may report the simultaneous UL transmission mode(s) to the basestation 102. That is, the UE 104 may report, to the basestation 102, that it supports simultaneous UL transmission across a band pair, that it does not support simultaneous UL transmission across a band pair, or that it both supports and does not support simultaneous UL transmission across a band pair. In particular of these embodiments, the UE 104 may report whether or not it supports simultaneous UL transmission across a band pair per band combination (BC). Also, the basestation 102 may configured the simultaneous UL transmission mode (e.g., switchedUL or dualUL) per cell group, which may be considered as per BC or per band pair in embodiments where a 2Tx user device supports only two bands. That is, one available band pair in a band combination may support one simultaneous UL transmission mode.

Additionally, in general as used herein, a band combination may include a plurality of bands (e.g., five bands). In addition, as used herein, a band group may include up to three or four bands. A given band group may be included in or part of a band combination. Also, a band combination and/or a band group may include at least one band pair, where a band pair includes two bands.

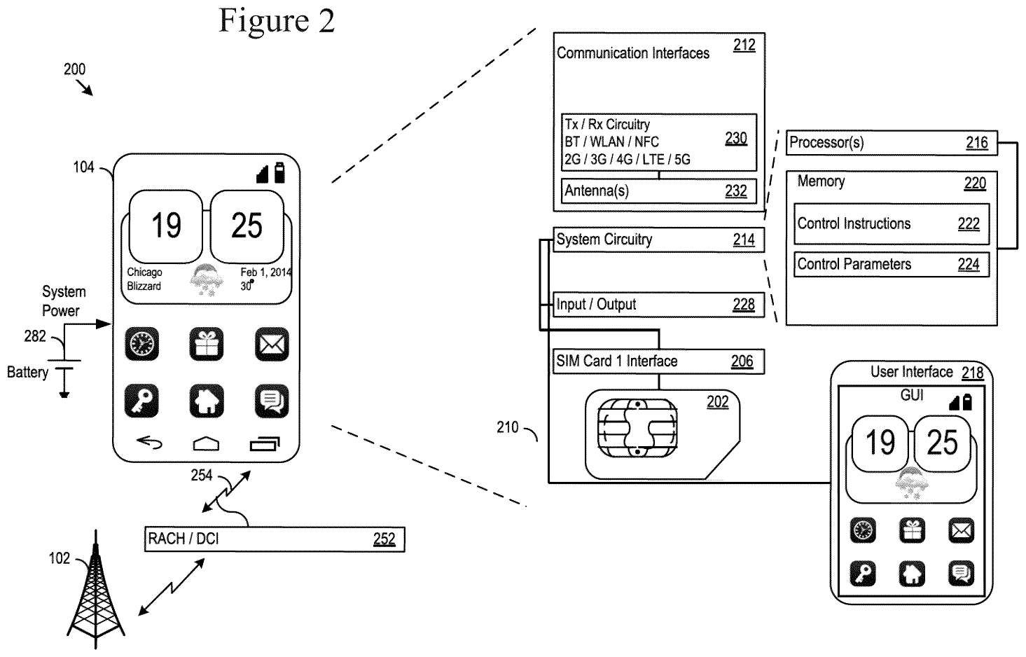

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC.

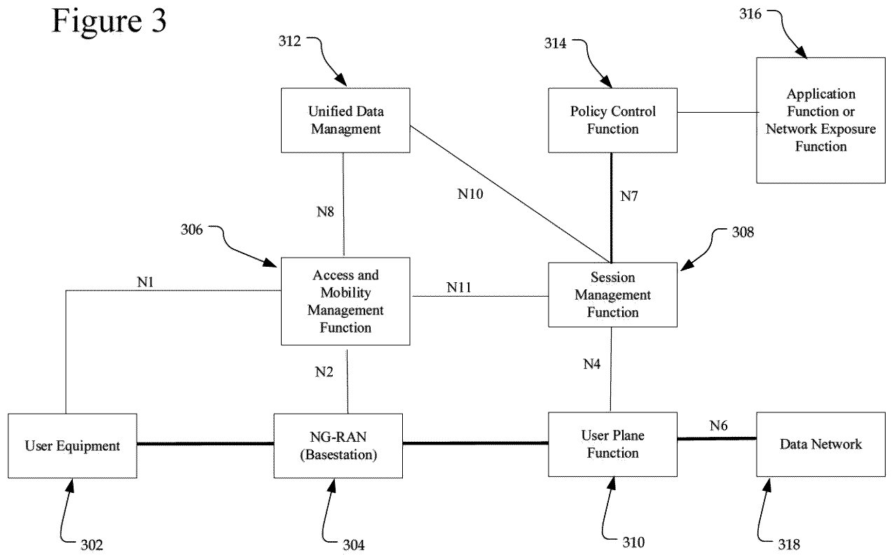

FIG. 3 shows one embodiment of a wireless network system architecture. This architecture is merely one example and there may be more or fewer components for implementing the embodiments described herein. The interconnections or communications between components are identified as N1, N2, N4, N6, N7, N8, N10, and N11, which may be referred to in the description or by other Figures. FIG. 2 illustrated an example user equipment (“UE”) 104. UE 302 is a device accessing a wireless network (e.g. 5GS) and obtaining service via a NG-RAN node or basestation 304. The UE 302 interacts with an Access and Mobility Control Function (“AMF”) 306 of the core network via NAS signaling. FIG. 1 illustrates an example basestation or NG-RAN 102. The basestation 304 may also be referred to as a next generation radio access network (“NG-RAN”) node and can provide a time synchronization signal to user equipment (UE). There may an AI model or processing method that is part of the UE 302 and information may be provided by the UE to components shown in FIG. 3 as described in the embodiments below.

The AMF 306 includes the following functionalities: Registration management, Connection management, Reachability management and Mobility Management. The AMF 306 also perform the access authentication and access authorization. The AMF 306 is the NAS security termination and relay the session management NAS between the UE 302 and the SMF 308, etc. The SMF 308 includes the following functionalities: Session Management e.g. Session establishment, modify and release, UE IP address allocation & management (including optional Authorization), Selection and control of uplink function, downlink data notification, etc. The user plane function (“UPF”) 310 includes the following functionalities: Anchor point for Intra-/Inter-RAT mobility, Packet routing & forwarding, Traffic usage reporting, QoS handling for user plane, downlink packet buffering and downlink data notification triggering, etc. The Unified Data Management (“UDM”) 312 manages the subscription profile for the UEs. The subscription includes the data used for mobility management (e.g. restricted area), session management (e.g. QoS profile). The subscription data also includes slice selection parameters, which are used for AMF 306 to select a proper SMF 308. The AMF 306 and SMF 308 get the subscription from the UDM 312. The subscription data may be stored in a Unified Data Repository with the UDM 312, which uses such data upon reception of request from AMF 306 or SMF 308. The Policy Control Function (“PCF”) 314 includes the following functionality: supporting unified policy framework to govern network behavior, providing policy rules to control plane function(s) to enforce the policy rule, and implementing a front end to access subscription information relevant for policy decisions in the User Data Repository. The Network Exposure Function (“NEF”) 316 is deployed optionally for exchanging information with an external third party. In one embodiment, an Application Function (“AF”) 316 may store the application information in the Unified Data Repository via NEF. The UPF 310 communicates with the data network 318.

The embodiments described below may include a UE determining of a parameter for adjustment to a maximum output power for a given power class based on an evaluation cycle and then the reporting of that parameter to the network/basestation. A given power class (PC) may also be referred to as a declared power class (PC) or a supported power class (PC) and those terms may be used interchangeably. This may be in the context of the network/wireless communication environment shown in FIGS. 1-3. This reporting may be triggered by a duty cycle being exceeded with a new event or based an expiration of a timer for a legacy event. The parameter may include ΔPPowerClass which is reported and used for realizing a high-power uplink transmission.

### Power Headroom Report

In some embodiments of a wireless communication system, for a single uplink (UL) carrier, a UE may be allowed to set its configured maximum output power P_{CMAX,f,c} for a carrier f of a serving cell c. The configured maximum output power P_{CMAX,f,c} may be set within the following bounds: P_{CMAX_L,f,c}≤P_{CMAX,f,c}≤P_{CMAX_H,f,c}, wherein P_{CMAX_L,f,c} and P_{CMAX_H,f,c} are depended on P_{PowerClass}, and P_{PowerClass,c} is the linear value of the maximum UE power for serving cell c or ue-PowerClass without taking into account the tolerance.

In some embodiments of a wireless communication system, for a uplink (UL) carrier aggregation (CA), a UE may be allowed to set its configured maximum output power P_{CMAX,c} for a serving cell c and its total configured maximum output power P_{CMAX}. The total configured maximum output power P_{CMAX} may be set within the following bounds: P_{CMAX_L}≤P_{CMAX}≤P_{CMAX_H}, wherein P_{CMAX_L} and P_{CMAX_H} are depended on P_{PowerClass,CA}. The maximum power class (PC) of the P_{PowerClass,CA} may be PC2, which the power can be used in UL CA is restricted by the P_{PowerClass,CA}. In some case, P_{PowerClass,CA} is replaced by 10 log₁₀ Σp_{PowerClass,c} which is also named as the aggregated power in UL CA, wherein P_{PowerClass,c} is the linear value of the maximum UE power for serving cell c or ue-PowerClass without taking into account the tolerance.

In some embodiments, a power headroom (PHR) calculation may be performed as following.

$$P {H}_{type 1 b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{R B , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

Wherein, P_{CMAX,f,c} (i) is the UE configured maximum output power for a carrier f of a serving cell c in PUSCH transmission occasion i. {P_{O_PUSCH,b,f,c}(j)+α_{b,f,c}(j)*PL_{b,f,c}(q_{d})} are related to open loop power control parameters, wherein P_{O_PUSCH,b,f,c}(j)=P_{O_NOMINAL,PUSCH,f,c}(j) (cell-specific)+P_{O_UE_PUSCH,b,f,c}(j) (UE-specific), {P_{O_UE_PUSCH,b,f,c}(j), α_{b,f,c}(j)} is determined by P0-PUSCH-AlphaSet and SRI indication; PL_{b,f,c}(q_{d}), is a downlink pathloss estimate in dB calculated by the UE using reference signal (RS) index q_{d} for the active DL BWP of carrier f of serving cell c.

Wherein, f_{b,f,c}(i,l) is related to closed loop power control parameter. For the PUSCH power control adjustment state f_{b,f,c}(i,l) for active UL BWP b of carrier f of serving cell c in PUSCH transmission occasion i. l∈{0,1}

$${f}_{b , f , c} ( i , l ) = {f}_{b , f , c} ( i - {i}_{0} , l ) + {\sum }_{m = 0}^{𝒞 ( {D}_{i} ) - 1} {δ}_{PUSCH , b , f , c} ( m , l ) ,$$

wherein δ_{PUSCH,b,f,c}(i,l) is a transmission power control (TPC) command value included in a DCI format 0_0 or DCI format 0_1 that schedules the PUSCH transmission occasion i on active UL BWP b of carrier f of serving cell c.

Wherein, M_{RB,b,f,c}^{PUSCH}(i) is the bandwidth of the PUSCH resource assignment expressed in number of resource blocks for PUSCH transmission occasion i on active UL BWP b of carrier f of serving cell c and μ is a SCS configuration. It is a resource block (RB) number for PUSCH, reflecting bandwidth impact on Tx power.

$${Δ}_{TF , b , f , c} ( i ) = 10 {log}_{10} ( ( {2}^{BPRE \cdot {K}_{s}} - 1 ) \cdot {β}_{offset}^{PUSCH} ) for {K}_{s} = 1.25$$

and Δ_{TF,b,f,c}(i)=0 for K_{S}=0 where K_{S} is provided by deltaMCS for each UL BWP b of each carrier f of serving cell c. It is a bits per resource element (BPRE) function, reflecting modulation and coding scheme (MCS) impact on transmission (Tx) power.

A Power Headroom Report (PHR) may be triggered if any of the following legacy events occur:
phr-ProhibitTimer expires or has expired and the path loss has changed more than phr-Tx-PowerFactorChange dB for at least one RS used as pathloss reference for one activated Serving Cell of any MAC entity of which the active DL BWP is not dormant BWP since the last transmission of a PHR in this MAC entity when the MAC entity has UL resources for new transmission;
phr-PeriodicTimer expires;
upon configuration or reconfiguration of the power headroom reporting functionality by upper layers, which is not used to disable the function;
activation of an SCell of any MAC entity with configured uplink of which firstActiveDownlinkBWP-Id is not set to dormant BWP;
activation of an SCG; and
addition of the PSCell except if the SCG is deactivated (i.e. PSCell is newly added or changed).

### UE Maximum Output Power

In some systems, the UE may support a different power class than the default UE power class for the band and the supported power class enables the higher maximum output power than that of the default power class. In one embodiment, the requirements for the supported power class may be applied and the configured transmitted power is set in one embodiment so that the UE is allowed to set its configured maximum output power P_{CMAX,f,c} for carrier f of serving cell c in each slot. The configured maximum output power P_{CMAX,f,c} may be set within the following bounds:
P_{CMAX_L,f,c}≤P_{CMAX,f,c}≤P_{CMAX_H,f,c} with
P_{CMAX_L,f,c}=MIN {P_{EMAX,c}−ΔT_{C,c}, (P_{PowerClass}−ΔP_{PowerClass})−MAX(MAX (MPR_{c}, A-MPR_{c})+ΔT_{IB,c}+ΔT_{C,c}+ΔT_{RxSRS}, P-MPR_{c})}
P_{CMAX_H,f,c}=MIN {P_{EMAX,c}, P_{PowerClass}−ΔP_{PowerClass}}

In some embodiments, the parameter ΔP_{PowerClass} may be set to be:
3 dB for a power class 2 capable UE or 6 dB for a power class 1.5 UE when P-max of 23 dBm or lower is indicated; or when the field of UE capability maxUplinkDutyCycle-PC2-FR1 is absent and the field of UE capability maxUplinkDutyCycle-PC1dot5-MPE-FR1 is absent and the percentage of uplink symbols transmitted in a certain evaluation period is larger than 50%; or when the field of UE capability maxUplinkDutyCycle-PC2-FR1 is not absent and the percentage of uplink symbols transmitted in a certain evaluation period is larger than maxUplinkDutyCycle-PC2-FR1, or when the field of UE capability maxUplinkDutyCycle-PC1dot5-MPE-FR1 is not absent and half the percentage of uplink symbols transmitted in a certain evaluation period is larger than maxUplinkDutyCycle-PC1dot5-MPE-FR1. The exact evaluation period may be no less than one radio frame.
3 dB for a power class 1.5 capable UE when P-max of between 23 dBm and 26 dB is indicated; or when the field of UE capability max UplinkDutyCycle-PC2-FR1 is absent and the field of UE capability maxUplinkDutyCycle-PC1dot5-MPE-FR1 is absent and the percentage of uplink symbols transmitted in a certain evaluation period is between 25% and 50%; or when the field of UE capability maxUplinkDutyCycle-PC2-FR1 is not absent and the percentage of uplink symbols transmitted in a certain evaluation period is between maxUplinkDutyCycle-PC2-FR1 and maxUplinkDutyCycle-PC2-FR1/2, or when the field of UE capability maxUplinkDutyCycle-PC1dot5-MPE-FR1 is not absent and the percentage of uplink symbols transmitted in a certain evaluation period is larger than maxUplinkDutyCycle-PC1dot5-MPE-FR1. The exact evaluation period may be no less than one radio frame.
3 dB when the UE is configured with SUL configurations and the requirements of default power class are applied on the band where UE indicates power class 2;
3 dB is applied during SRS transmission occasions with usage in SRS-ResourceSet set as ‘antennaSwitching’ with configured SRS resources in each SRS resource set(s) consisting of one SRS port when PC2 capable UE with txDiversity-r16 capability or PC1.5 capable UE further indicates SRS-TxSwitch capability ‘t1r2’ or ‘t1r4’ or ‘t1r1-t1r2’ or ‘t1r1-t1r2-t1r4’; or
0 dB otherwise.

In some embodiments, when the UE may support a different power class than the default UE power class for the band and the supported power class enables the higher maximum output power than that of the default power class then the following may be implemented:
if the field of UE capability maxUplinkDutyCycle-PC2-FR1 is absent and the field of UE capability maxUplinkDutyCycle-PC1dot5-MPE-FR1 is absent and the percentage of uplink symbols transmitted in a certain evaluation period is larger than 50% (The exact evaluation period is no less than one radio frame); or
if the field of UE capability maxUplinkDutyCycle-PC2-FR1 is not absent and the percentage of uplink symbols transmitted in a certain evaluation period is larger than maxUplinkDutyCycle-PC2-FR1; or
if the field of UE capability maxUplinkDutyCycle-PC1dot5-MPE-FR1 is not absent and half the percentage of uplink symbols transmitted in a certain evaluation period is larger than maxUplinkDutyCycle-PC1dot5-MPE-FR1; or
if the IE P-Max is provided and set to the maximum output power of the default power class or lower.

In one embodiment, all requirements for the default power class may be applied to the supported power class and the configured transmitted power is set accordingly. This may occur when the UE does not support a power class with higher maximum output power than PC2. In some embodiments, when the UE may support a different power class than the default UE power class for the band and the supported power class enables the higher maximum output power than that of the default power class then the following may be implemented:
if the field of UE capability maxUplinkDutyCycle-PC2-FR1 is absent and the field of UE capability maxUplinkDutyCycle-PC1dot5-MPE-FR1 is absent and the percentage of uplink symbols transmitted in a certain evaluation period is larger than 25%; or
if the field of UE capability maxUplinkDutyCycle-PC2-FR1 is not absent and the percentage of uplink symbols transmitted in a certain evaluation period is larger than 0.5*maxUplinkDutyCycle-PC2-FR1;
if UE capability maxUplinkDutyCycle-PC1dot5-MPE-FR1 is not absent and the percentage of uplink symbols transmitted in a certain evaluation period is larger than maxUplinkDutyCycle-PC1dot5-MPE-FR1; or
if the IE P-Max is provided and set to the maximum output power of the power class 2 or lower; or
all requirements for power class 2 may be applied to the supported power class and the configured transmitted power is set.

### Parameter Reporting in PHR

The power headroom report (PHR) includes reporting of a parameter for adjustment to a maximum output power for a given power class. This parameter may be referred to as ΔP_{PowerClass} which is reported and used for realizing a high-power uplink transmission. The parameter is determined by user equipment (UE) based on evaluation of a duty cycle and reported to the network/basestation when triggered by a duty cycle being exceeded with a new event or based an expiration of a timer for a legacy event. The embodiments below include examples of the parameter determination and reporting, include the event triggering.

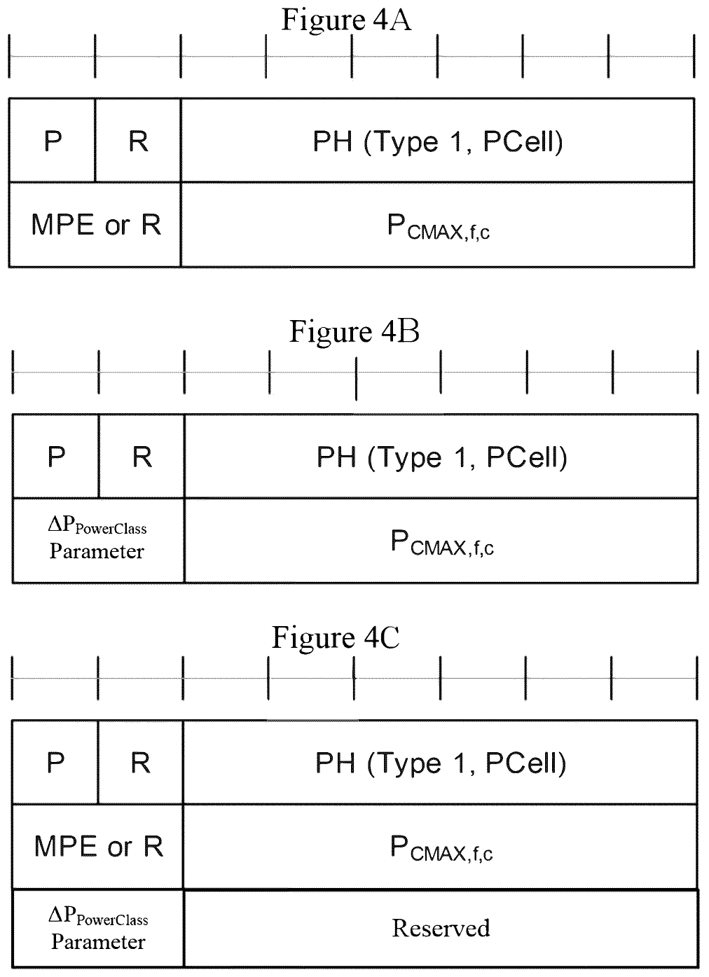

FIG. 4A illustrates one example of a power headroom report (PHR) structure. FIG. 4B illustrates another example of a PHR structure with a parameter for adjustment to a maximum output power for a given power class. For power headroom reporting, there are may be several PHR MAC control elements (CE), including: Single Entry PHR MAC CE, Multiple Entry PHR MAC CE, Enhanced Single Entry PHR MAC CE, Enhanced Multiple Entry PHR MAC CE, Enhanced Single Entry PHR for multiple TRP MAC CE, or Enhanced Multiple Entry PHR for multiple TRP MAC CE. Using the Single Entry PHR MAC CE as an example, for the 2-bit MPE field, it may be used for FR2 and reserved for FR1, but can be reused for FR1. R may be the reserved bit, while MPE is reserved for FR1. ΔP_{PowerClass} may be applied for FR1. Since 2-bit may be needed for a UE to report the ΔP_{PowerClass}, the MPE field for FR2 may be reused to report ΔP_{PowerClass} for FR1. FIG. 4B illustrates this field being replaced with the parameter for adjustment to a maximum output power for a given power class, which is referred to as ΔP_{PowerClass}. FIG. 4C illustrates another example of a PHR structure with a parameter for adjustment to a maximum output power for a given power class, that using partial or all bits within an independent octet to report the ΔP_{PowerClass}. For example, compared with FIG. 4A, a third octet is used and X bits are used to report the ΔP_{PowerClass}, where X could be 1, 2, 3, 4, 5, 6, 7 or 8.

When mpe-Reporting-FR2 is configured, and the Serving Cell (SC) operates on FR2, and if the P field is set to 1, this field may indicate the applied power back-off to meet MPE requirements. The length of the field is 2 bits. If mpe-Reporting-FR2 is not configured, or if the SC operates on FR1, or if the P field is set to 0, R bits may be present instead.

With regard to the enhanced information exchange/communications between the UE and basestation can improve scheduling and network performance when using a higher power. Accordingly, providing improved communications and reporting on power usage, specifically enabling a UE report on the ΔP_{PowerClass} can indicate which power class requirements that the UE is referring to when the configured duty cycle is exceeded. In some embodiments, the report may be limited to when the configured duty cycle is exceeded. This may be referred to as an event. There may be different triggering events described herein.

In addition to the configured duty cycle, there may be default duty cycle cases. For example, when the field of UE capability maxUplinkDutyCycle-PC2-FR1 is absent and the field of UE capability max UplinkDutyCycle-PC1dot5-MPE-FR1 is absent and the percentage of uplink symbols transmitted in a certain evaluation period is larger than 50%, ΔP_{PowerClass}=3 dB for a power class 2 capable UE or 6 dB for a power class 1.5 UE. If the default duty cycle is exceeded, ΔP_{PowerClass} may be reported. For example, when the field of UE capability max UplinkDutyCycle-PC2-FR1 is absent and the field of UE capability max UplinkDutyCycle-PC1dot5-MPE-FR1 is absent and the percentage of uplink symbols transmitted in a certain evaluation period is larger than 50%, ΔP_{PowerClass} may be reported because the power class requirements that the UE is referring to is reduced, which is similar as the configured duty cycle case.

In other embodiments, there may be a default/configured duty cycle that is partial exceeded. For example, when the field of UE capability max UplinkDutyCycle-PC2-FR1 is absent and the field of UE capability max UplinkDutyCycle-PC1dot5-MPE-FR1 is absent and the percentage of uplink symbols transmitted in a certain evaluation period is between 25% and 50%; or when the field of UE capability maxUplinkDutyCycle-PC2-FR1 is not absent and the percentage of uplink symbols transmitted in a certain evaluation period is between maxUplinkDutyCycle-PC2-FR1 and maxUplinkDutyCycle-PC2-FR1/2, then the parameter ΔP_{PowerClass}=3 dB for a power class 1.5 UE. If the default/configured duty cycle is partially exceeded, ΔP_{PowerClass} may be reported. Partially exceeded may include between 25-50% in one example, but could include other percentages less than 25 and greater than 50%. For example, when the field of UE capability max UplinkDutyCycle-PC2-FR1 is absent and the field of UE capability max UplinkDutyCycle-PC1dot5-MPE-FR1 is absent and the percentage of uplink symbols transmitted in a certain evaluation period is between 25% and 50%, the parameter ΔP_{PowerClass} may be reported because the power class requirements that the UE is referring to is reduced, which is similar to the above example when the duty cycle is completely exceeded.

In other embodiments, the configured duty cycle may be exceeded by half the percentage of uplink symbols transmitted in a certain evaluation period. For example, when the field of UE capability max UplinkDutyCycle-PC1dot5-MPE-FR1 is not absent and half the percentage of uplink symbols transmitted in a certain evaluation period is larger than max UplinkDutyCycle-PC1dot5-MPE-FR1, the parameter ΔP_{PowerClass}=6 dB for a power class 1.5 UE. If the default/configured duty cycle is exceeded by half the percentage of uplink symbols transmitted in a certain evaluation period, ΔP_{PowerClass} may be reported. For example, when the field of UE capability max UplinkDutyCycle-PC1dot5-MPE-FR1 is not absent and half the percentage of uplink symbols transmitted in a certain evaluation period is larger than max UplinkDutyCycle-PC1dot5-MPE-FR1, then the parameter ΔP_{PowerClass} may be reported because the power class requirements that the UE is referring to is reduced. This may be similar to the above example when the duty cycle is completely exceeded or exceeded by the percentage of uplink symbols transmitted in a certain evaluation period.

The embodiments may enable the UE to properly report on the parameter ΔP_{PowerClass} to indicate which power class requirements that the UE is referring to not only when configured duty cycle is exceeded, but also when default duty cycle is exceeded or when default/configured duty cycle is partially exceeded. At least the reduced power class can be known for both the network/basestation and the UE. This may allow for better utilization of the max power of the UE to improve network/basestation scheduling decisions.

The transmission of the parameter for adjustment to a maximum output power for a given power class may be used to improve scheduling and network performance when using higher power. This reporting on the ΔP_{PowerClass} by the UE may indicate which power class requirements that the UE is referring to when default/configured duty cycle is partially/completely exceeded. The reporting may be limited to when configured duty cycle is exceeded. Since the enhanced PHR includes the indication of ΔP_{PowerClass}, the embodiments for how to report ΔP_{PowerClass} in PHR are described herein. In some examples, the reported value of ΔP_{PowerClass} is cumulative value or absolute value. Also, the reported value of ΔP_{PowerClass} may be different when triggered by a legacy event.

PHR with an actual value for the ΔP_{PowerClass} can be only triggered by a new event. Otherwise, there may be a default value of 0 dB for the ΔP_{PowerClass}. The new event may include when configured duty cycle is exceeded. A PHR may include a value of 0 dB for the ΔP_{PowerClass} when triggered by a legacy event. The actual value for the ΔP_{PowerClass} may be an absolute value or accumulate value. The potential indication of ΔP_{PowerClass} may be shown in Table 1 showing a 2 bits indication or in Table 2 or 3 showing a 1-bit indication.

TABLE 1
Example indication of ΔP_{PowerClass} with 2 bits indication.

| ΔP_{PowerClass} | value |
|---|---|
| 0 | 0 dB |
| 1 | 3 dB |
| 2 | 6 dB |
| 3 | Reserved (or for other value, e.g. 9 dB) |

TABLE 2
Example indication of ΔP_{PowerClass} with 1 bit indication.

| ΔP_{PowerClass} | value |
|---|---|
| 0 | 0 dB |
| 1 | Non zero value (3 dB or 6 dB) |

TABLE 3
Another example indication of ΔP_{PowerClass} with 1-bit indication.

| ΔP_{PowerClass} | value |
|---|---|
| 0 | 3 dB |
| 1 | 6 dB |

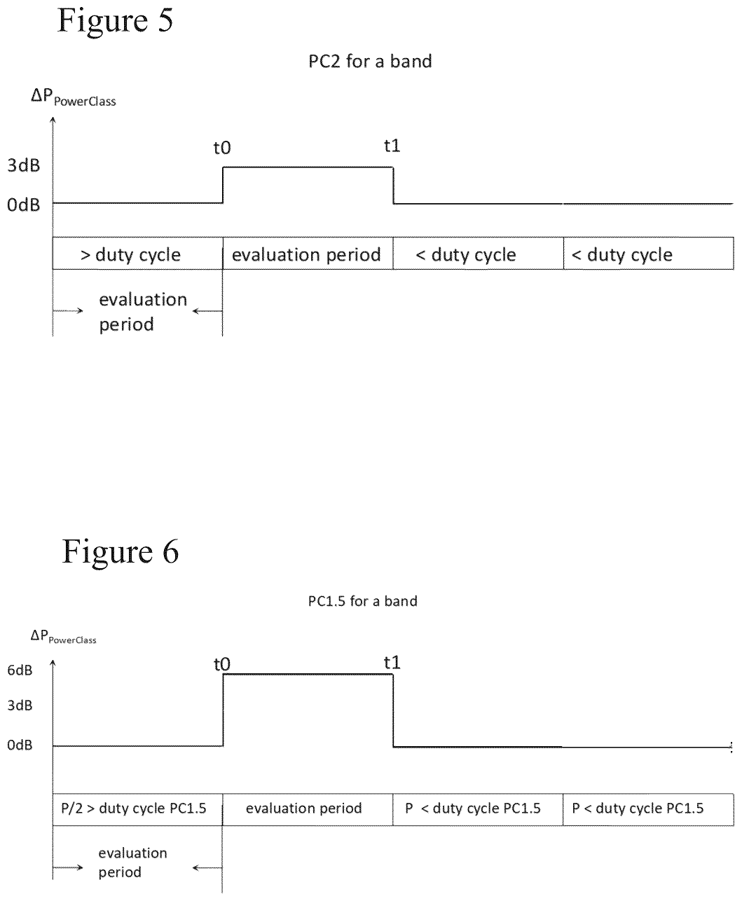

FIG. 5 illustrates timing for a PC2 band example. In this example, ΔP_{PowerClass}=3 dB is reported in FIG. 5 at t0-t1, and otherwise 0 dB is reported. The duration of power class fallback equals to the evaluation period, and if duty cycle is exceeded in the first evaluation period, ΔP_{PowerClass}=3 dB in PHR is triggered at to by the new event. As a result, PC3 may be assumed in the second evaluation period. During t0<t<t1, ΔP_{PowerClass}=0 dB in PHR is triggered when triggered by a legacy event. After the duration of power class fallback, if PHR is triggered by a legacy event or another new event of returning to declared PC2, ΔP_{PowerClass}=0 dB in PHR. If the duty cycle is not exceeded after an evaluation period, ΔP_{PowerClass}=0 dB in PHR when triggered by a legacy event. A summary of a detailed reported value is listed in Table 4.

TABLE 4
An example of detailed reported value.

| Trigger time | ΔP_{PowerClass} in PHR | Event |
|---|---|---|
| t = t0 | 3 dB | New event (configured duty cycle |
| | | is exceeded) |
| t0 < t < t1 | 0 dB | Legacy event if any |
| t = t1 | 0 dB | Legacy event if any (or introduce |
| | | another new event of returning |
| | | to declared PC) |
| t > t1 | 0 dB | Legacy event if any |

FIG. 6 illustrates timing for a PC1.5 band example. This includes duration of PC fallback compared to the evaluation period. In this example, ΔP_{PowerClass}=6 dB at t0-t1, and otherwise 0 dB is reported. PC1.5 may have potential values of 0, 3, or 6 dB. As shown, duration of power class fallback equals to the evaluation period. If duty cycle is exceeded by half the percentage of uplink symbols transmitted in a certain evaluation period in the first evaluation period, ΔP_{PowerClass}=6 dB in PHR is triggered at to by the new event. As a result, PC3 may be assumed in the second evaluation period. During t0<t<t1, ΔP_{PowerClass}=0 dB in PHR is triggered if triggered by a legacy event. After the duration of power class fallback, if PHR is triggered by a legacy event or another new event of returning to declared PC1.5, ΔP_{PowerClass}=0 dB in PHR. After the duration of power class fallback, if PHR is triggered by a legacy event or another new event for returning to the declared PC2, ΔP_{PowerClass}=3 dB in PHR if the percentage of uplink symbols transmitted in a certain evaluation period is larger than a duty cycle. If the duty cycle is not exceeded after an evaluation period, ΔP_{PowerClass}=0 dB in PHR when triggered by a legacy event. A summary of detailed reported value is listed in Table 5.

TABLE 5
An example of detailed reported value.

| Trigger time | ΔP_{PowerClass} in PHR | Event |
|---|---|---|
| t = t0 | 6 dB | New event (configured duty cycle |
| | | exceeded) |
| t0 < t < t1 | 0 dB | Legacy event if any |
| t = t1 | 0 dB (or 3 dB) | Legacy event if any (or introduce |
| | | another new event of returning |
| | | to declared PC or another PC) |
| t > t1 | 0 dB | Legacy event if any |

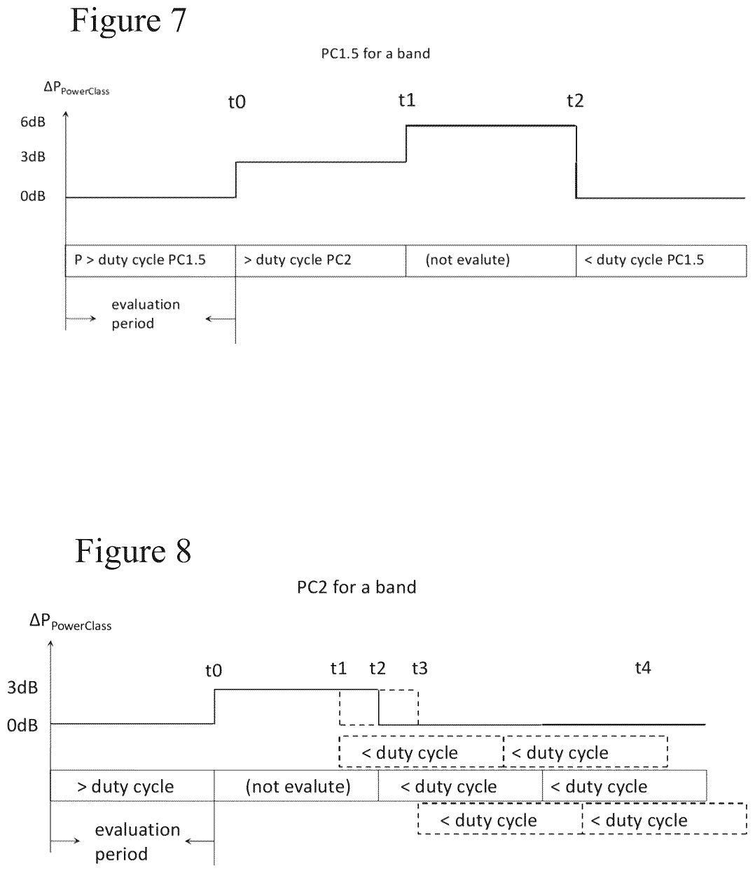

FIG. 7 illustrates timing for another PC1.5 band example. In this example, in the first evaluation period, the duty cycle is exceeded, so 3 dB is set. In the second evaluation period, the duty cycle is exceeded, then it is set to 6 dB. As shown, a duration of power class fallback equals to the evaluation period. If the duty cycle is exceeded by the percentage of uplink symbols transmitted in a certain evaluation period in the first evaluation period, ΔP_{PowerClass}=3 dB in PHR is triggered at t0 by the new event. As a result, PC2 may be assumed in the second evaluation period. During t0<t<t1, ΔPPowerClass=0 dB in PHR is triggered when triggered by a legacy event. After a duration of PC2, if the duty cycle is exceeded by the percentage of uplink symbols transmitted in a certain evaluation period in the second evaluation period, ΔPPowerClass=3 dB (accumulate value) or 6 dB (absolute value) in PHR is triggered at t1 by the new event. As a result, PC3 may be assumed in the third evaluation period. If PHR is triggered by a legacy event or another new event of returning to the declared PC1.5, ΔP_{PowerClass}=0 dB in PHR. After the duration of power class fallback, if PHR is triggered by a legacy event or another new event of returning to declared PC2, ΔP_{PowerClass}=3 dB in PHR if the percentage of uplink symbols transmitted in a certain evaluation period is larger than a duty cycle. If the duty cycle is not exceeded after an evaluation period, ΔP_{PowerClass}=0 dB in PHR if triggered by a legacy event. A summary of detailed reported value is listed in Table 6.

TABLE 6
An example of detailed reported value.

| Trigger time | ΔP_{PowerClass} in PHR | Event |
|---|---|---|
| t = t0 | 3 dB | New event (configured duty cycle |
| | | is exceed) |
| t0 < t < t1 | 0 dB | Legacy event if any |
| t = t1 | 3 dB (or 6 dB) | New event (configured duty cycle |
| | | is exceed) |
| t1 < t < t2 | 0 dB | Legacy event if any |
| t = t2 | 0 dB (or 3 dB) | Legacy event if any (or introduce |
| | | another new event of returning |
| | | to declared PC or another PC) |
| t > t2 | 0 dB | Legacy event if any |

The embodiments described enable UE reporting on the actual value of ΔP_{PowerClass} to indicate which power class requirements that the UE is referring to when configured duty cycle is exceeded. Otherwise, the value is 0 dB. With this reporting, the reduced power class can be known for both the network/basestation and the UE. It may be more efficient to utilize the max power of the UE to improve basestation scheduling decisions.

In some embodiments, the triggering may be modified. Examples described below include further examples showing the triggering. PHR with actual value for the ΔP_{PowerClass} can be triggered by any one of a new event and a legacy event. The actual value (absolute value rather than cumulative) of ΔP_{PowerClass} may be reported. The new event may include when the configured duty cycle is exceeded. The actual value for the ΔP_{PowerClass} could be the absolute value. The potential indication of ΔP_{PowerClass} may be shown in the Table 1 with 2-bit indication or Table 2 or 3 with 1-bit indication.

The embodiments shown in FIGS. 5-7 and Tables 1-6 include different values for ΔP_{PowerClass}. The following embodiments rely on FIGS. 5-7 but illustrate different Tables that include different values for the parameter. References will be made back to FIGS. 5-7 discussed above but in the context of the Tables presented below. FIG. 5 illustrates timing for a PC2 band example where duration of PC fallback equals the evaluation period. As shown, ΔP_{PowerClass}=3 dB at t0 or t0<t<t1. As shown, the duration of power class fallback equals to the evaluation period. If the duty cycle is exceeded in the first evaluation period, ΔP_{PowerClass}=3 dB in PHR is triggered at t0 by the new event. As a result, PC3 may be assumed in the second evaluation period. During t0<t<t1, ΔP_{PowerClass}=3 dB in PHR is triggered when triggered by a legacy event. After the duration of power class fallback, if PHR is triggered by a legacy event or another new event of returning to declared PC2, ΔP_{PowerClass}=0 dB in PHR. If the duty cycle is not exceeded after an evaluation period, ΔP_{PowerClass}=0 dB in PHR if triggered by a legacy event. A summary of detailed reported value is listed in Table 7.

TABLE 7
An example of detailed reported value.

| Trigger time | ΔP_{PowerClass} in PHR | Event |
|---|---|---|
| t = t0 | 3 dB | New event (configured duty cycle |
| | | exceeded) |
| t0 < t < t1 | 3 dB | Legacy event if any |
| t = t1 | 0 dB | Legacy event if any (or introduce |
| | | another new event of returning to |
| | | declared PC) |
| t > t1 | 0 dB | Legacy event if any |

FIG. 6 illustrates timing for a PC1.5 band example where duration of PC fallback equals the evaluation period. FIG. 6 illustrates timing for a PC2 band example where duration of PC fallback equals the evaluation period. As shown, ΔP_{PowerClass}=6 dB at t0 or t0<t<t1. As shown, the duration of power class fallback equals to the evaluation period. If the duty cycle is exceeded by half the percentage of uplink symbols transmitted in a certain evaluation period in the first evaluation period, ΔP_{PowerClass}=6 dB in PHR is triggered at t0 by the new event. As a result, PC3 may be assumed in the second evaluation period. During t0<t<t1, ΔP_{PowerClass}=6 dB in PHR is triggered when triggered by a legacy event. After the duration of power class fallback, if PHR is triggered by a legacy event or another new event of returning to the declared PC1.5, ΔP_{PowerClass}=0 dB in PHR. After the duration of power class fallback, if PHR is triggered by a legacy event or another new event of returning to declared PC2, ΔP_{PowerClass}=3 dB in PHR if the percentage of uplink symbols transmitted in a certain evaluation period is larger than a duty cycle. If duty cycle is not exceeded after an evaluation period, ΔP_{PowerClass}=0 dB in PHR if triggered by a legacy event. A summary of detailed reported value is listed in Table 8.

TABLE 8
An example of detailed reported value.

| Trigger time | ΔP_{PowerClass} in PHR | Event |
|---|---|---|
| t = t0 | 6 dB | New event (configured duty cycle |
| | | exceeded) |
| t0 < t < t1 | 6 dB | Legacy event if any |
| t = t1 | 0 dB (or 3 dB) | Legacy event if any (or introduce |
| | | another new event of returning to |
| | | declared PC or another PC) |
| t > t1 | 0 dB | Legacy event if any |

FIG. 7 illustrates timing for another PC1.5 band example where duration of PC fallback equals the evaluation period. As shown, duration of power class fallback equals to the evaluation period. If duty cycle is exceeded by the percentage of uplink symbols transmitted in a certain evaluation period in the first evaluation period, ΔP_{PowerClass}=3 dB in PHR is triggered at to by the new event. As a result, PC2 may be assumed in the second evaluation period. During t0<t<t1, ΔP_{PowerClass}=3 dB in PHR is triggered when triggered by a legacy event. After a duration of PC2, if the duty cycle is exceeded by the percentage of uplink symbols transmitted in a certain evaluation period in the second evaluation period, ΔP_{PowerClass}=6 dB (absolute value), 3 dB (accumulate value), or in PHR is triggered at t1 by the new event. As a result, PC3 may be assumed in the third evaluation period. During t1<t<t2, ΔP_{PowerClass}=6 dB in PHR is triggered if triggered by a legacy event. If PHR is triggered by a legacy event or another new event of returning to declared PC1.5, ΔP_{PowerClass}=0 dB in PHR. After the duration of power class fallback, if PHR is triggered by a legacy event or another new event of returning to declared PC2, ΔP_{PowerClass}=3 dB in PHR if the percentage of uplink symbols transmitted in a certain evaluation period is larger than a duty cycle. If the duty cycle is not exceeded after an evaluation period, ΔP_{PowerClass}=0 dB in PHR if triggered by a legacy event. A summary of detailed reported value is listed in Table 9.

TABLE 9
An example of detailed reported value.

| Trigger time | ΔP_{PowerClass} in PHR | Event |
|---|---|---|
| t = t0 | 3 dB | New event (configured duty cycle |
| | | exceeded) |
| t0 < t < t1 | 3 dB | Legacy event if any |
| t = t1 | 6 dB (or 3 dB) | New event (configured duty cycle |
| | | exceeded) |
| t1 < t < t2 | 6 dB | Legacy event if any |
| t = t2 | 0 dB (or 3 dB) | Legacy event if any (or introduce |
| | | another new event of returning to |
| | | declared PC or another PC) |
| t > t2 | 0 dB | Legacy event if any |

The embodiments may enable a UE report on the actual value of ΔP_{PowerClass} to indicate which power class requirements that the UE is referring to when the configured duty cycle is exceeded or triggered by a legacy event. The reduced power class may be known for both the network/basestation and the UE. It may allow for higher efficiency and utilization of the max power of the UE to improve network/basestation scheduling decisions.

### Legacy Event Trigger

The embodiments shown in FIGS. 5-7 and Tables 1-6 include different trigger examples. The following embodiments rely on FIGS. 5-7 but illustrate different Tables that include different values for the parameter and different triggering. References will be made back to FIGS. 5-7 discussed above but in the context of the Tables presented below. PHR with actual values for the ΔP_{PowerClass} are triggered by the new event, and if PHR is triggered by a legacy event, no value of ΔP_{PowerClass} is reported which means PHR is triggered by the legacy event. An independent reserved state for the ΔP_{PowerClass} may be used as described in the embodiments below. The new event may be when the configured duty cycle is exceeded. An actual value for the ΔP_{PowerClass} could be the absolute value or accumulated value. The potential indication of ΔP_{PowerClass} may be shown in Tables 10-13 for various embodiments with 2-bit indication or 1-bit indication.

TABLE 10
Example indication of ΔP_{PowerClass} with 2 bits indication.

| ΔP_{PowerClass} | value |
|---|---|
| 0 | Reserved for legacy event which is not the new event |
| 1 | 0 dB |
| 2 | 3 dB |
| 3 | 6 dB |

TABLE 11
Another example indication of ΔP_{PowerClass} with 2-bit indication.

| ΔP_{PowerClass} | value |
|---|---|
| 0 | 0 dB |
| 1 | 3 dB |
| 2 | 6 dB |
| 3 | Reserved for legacy event which is not the new event |

TABLE 12
Example indication of ΔP_{PowerClass} with 1-bit indication.

| ΔP_{PowerClass} | value |
|---|---|
| 0 | reserved |
| 1 | Non zero value (3 dB or 6 dB) |

TABLE 13
Another example indication of ΔP_{PowerClass} with 1-bit indication.

| ΔP_{PowerClass} | value |
|---|---|
| 0 | reserved |
| 1 | actual value (0 dB, 3 dB or 6 dB) |

As shown in FIG. 5, a duration of power class fallback equals to the evaluation period. If the duty cycle is exceeded in the first evaluation period, ΔP_{PowerClass}=3 dB in PHR is triggered at t0 by the new event. As a result, PC3 may be assumed in the second evaluation period. During t0<t<t1, ΔP_{PowerClass}=Reserved in PHR is triggered if triggered by a legacy event. After the duration of power class fallback, if PHR is triggered by a legacy event or another new event of returning to declared PC2, ΔP_{PowerClass}=Reserved or 0 dB in PHR. If the duty cycle is not exceeded after an evaluation period, ΔP_{PowerClass}=Reserved in PHR if triggered by legacy event. A summary of detailed reported value is listed in Table 14.

TABLE 14
An example of detailed reported value.

| Trigger time | ΔP_{PowerClass} in PHR | Event |
|---|---|---|
| t = t0 | 3 dB | New event (configured duty cycle |
| | | exceeded) |
| t0 < t < t1 | Reserved | Legacy event if any |
| t = t1 | Reserved (or 0 dB) | Legacy event if any (or introduce |
| | | another new event of returning to |
| | | declared PC) |
| t > t1 | Reserved | Legacy event if any |

As shown in FIG. 6, a duration of power class fallback equals to the evaluation period. If the duty cycle is exceeded by half the percentage of uplink symbols transmitted in a certain evaluation period in the first evaluation period, ΔP_{PowerClass}=6 dB in PHR is triggered at t0 by the new event. As a result, PC3 may be assumed in the second evaluation period. During t0<t<t1, ΔP_{PowerClass}=Reserved in PHR is triggered if triggered by a legacy event. After the duration of power class fallback, if PHR is triggered by a legacy event or another new event of returning to declared PC1.5, ΔP_{PowerClass}=Reserved or 0 dB in PHR. After the duration of power class fallback, if PHR is triggered by a legacy event or another new event of returning to declared PC2, ΔP_{PowerClass}=3 dB in PHR if the percentage of uplink symbols transmitted in a certain evaluation period is larger than a duty cycle. If the duty cycle is not exceeded after an evaluation period, ΔP_{PowerClass}=Reserved in PHR if triggered by a legacy event. A summary of detailed reported value is listed in Table 15.

TABLE 15
An example of detailed reported value.

| Trigger time | ΔP_{PowerClass} in PHR | Event |
|---|---|---|
| t = t0 | 6 dB | New event (configured duty cycle is |
| | | exceed) |
| t0 < t < t1 | Reserved | Legacy event if any |
| t = t1 | Reserved (or 0 dB | Legacy event if any (or introduce |
| | (or 3 dB)) | another new event of returning to |
| | | declared PC or another PC) |
| t > t1 | Reserved | Legacy event if any |

As shown in FIG. 7, a duration of power class fallback equals to the evaluation period. If the duty cycle is exceeded by the percentage of uplink symbols transmitted in a certain evaluation period in the first evaluation period, ΔP_{PowerClass}=3 dB in PHR is triggered at t0 by the new event. As a result, PC2 will be assumed in the second evaluation period. During t0<t<t1, ΔP_{PowerClass}=Reserved in PHR is triggered if triggered by a legacy event. After a duration of PC2, if a duty cycle is exceeded by the percentage of uplink symbols transmitted in a certain evaluation period in the second evaluation period, ΔP_{PowerClass}=6 dB (absolute value) or 3 dB (accumulate value), or in PHR is triggered at t1 by the new event. As a result, PC3 may be assumed in the third evaluation period. During t1<t<t2, ΔP_{PowerClass}=Reserved in PHR is triggered if triggered by a legacy event. If PHR is triggered by a legacy event or another new event of returning to declared PC1.5, ΔP_{PowerClass}=Reserved or 0 dB in PHR. After the duration of power class fallback, if PHR is triggered by a legacy event or another new event of returning to declared PC2, ΔP_{PowerClass}=3 dB in PHR if the percentage of uplink symbols transmitted in a certain evaluation period is larger than a duty cycle. If a duty cycle is not exceeded after an evaluation period, ΔP_{PowerClass}=Reserved in PHR if triggered by a legacy event. A summary of detailed reported value is listed in Table 16.

TABLE 16
An example of detailed reported value.

| Trigger time | ΔP_{PowerClass} in PHR | Event |
|---|---|---|
| t = t0 | 3 dB | New event (configured duty cycle |
| | | exceeded) |
| t0 < t < t1 | Reserved | Legacy event if any |
| t = t1 | 6 dB (or 3 dB) | New event (configured duty cycle |
| | | exceeded) |
| t1 < t < t2 | Reserved | Legacy event if any |
| t = t2 | Reserved or (0 dB | Legacy event if any (or introduce |
| | (or 3 dB)) | another new event of returning to |
| | | declared PC or another PC) |
| t > t2 | Reserved | Legacy event if any |

The embodiments may enable a UE report on the actual value of ΔP_{PowerClass} to indicate which power class requirements that the UE is referring to when the configured duty cycle is exceeded or triggered by a legacy event. The reduced power class may be known for both the network/basestation and the UE. It may allow for higher efficiency and utilization of the max power of the UE to improve network/basestation scheduling decisions.

The improved/enhanced information exchange between the UE and the network/basestation may improve scheduling and network performance when using higher power by enabling the UE to report on the ΔP_{PowerClass} to indicate which power class requirements that the UE is referring to when the default/configured duty cycle is partially/completely exceeded. The timing of the report may be limited to when configured duty cycle is exceeded. Since an actual value or 0 dB or reserved state for ΔP_{PowerClass} may be reported upon a legacy event, if both a new event and a legacy event are simultaneously triggered the PHR may need to modify how to report the ΔP_{PowerClass}. In a first embodiment, the report may be triggered by the new event as priority, with the actual value for ΔP_{PowerClass} being reported. In a second embodiment, the report may be triggered by the legacy event as priority, with the actual value or 0 dB or reserved state for ΔP_{PowerClass} being reported.

FIG. 11 illustrates timing for a band example where duration of PC fallback does not equal the evaluation period. After reporting ΔP_{PowerClass}, there may an issue for how long will the power class fallback will last. If new event for returning to declared PC is not introduced, and there is no PHR sent when returning to the declared PC, the network/basestation may not know the accurate PC. As shown in FIG. 11, if UE could return the declared PC2 at t1/t2/t3, the network/basestation will still schedule the UE assuming PC3 on the band until the next PHR assumed at t4. There may be two conditions for the relation between the duration of PC fallback and the evaluation period. A first condition includes a duration of PC fallback is equal to the evaluation period. A second condition includes a duration of PC fallback is not equal to the evaluation period. Besides enabling the UE report on the ΔP_{PowerClass} to indicate which power class requirements that the UE is referring to when the default/configured duty cycle is partially/completely exceeded, one of following embodiments may be used:
PHR is triggered by new event for returning to declared PC (for either condition); or
PHR triggered by legacy event for returning to declared PC by roughly match (for the first condition) or smaller (for the second condition) than the evaluation period, a timer which is no larger than the evaluation period. For example, phr-PeriodicTimer expires, and configures a smaller value of phr-PeriodicTimer in order to be the same as or less than the evaluation period, including configuring phr-PeriodicTimer=sf10;
Declared PC will be returned after a time offset from the PHR triggered by new event (e.g. configured duty cycle is exceeded). The time offset may be determined in different examples:
   The timer for the first condition (the intention is equal to the evaluation period);
   A predefined/reported/configured value for the second condition (the intention is less than the evaluation period); or
   A timer defined for returning to the declared PC for either condition. This timer may be started when the PHR triggered by new event (e.g. configured duty cycle is exceeded) and return to the declared PC when the timer is expired and reset to 0.
Declared PC will be returned if another report triggered after a time offset from the PHR triggered by a new event (e.g. configured duty cycle is exceeded). There may be the following alternatives:
   a timer for the first condition (the intention is equal to the evaluation period);
   a predefined/reported/configured value for the second condition (the intention is less than the evaluation period); or
   a timer defined for returning to the declared PC for either condition. The timer may be started when the PHR triggered by new event (e.g. configured duty cycle is exceeded) and trigger another report when the timer is expired and reset to 0. For example, as shown in FIG. 11, a timer is started when the PHR triggered by the new event at t0, another PHR is triggered when the timer is expired at t1 with ΔP_{PowerClass}=3 dB. Power class fallback is still applied and there is no return to the declared PC, the timer is reset and started. Another PHR is triggered when the timer is expired at t3 with ΔP_{PowerClass}=0 dB, then declared PC will be returned.

In some embodiments, there may be full-power MIMO transmission capability reporting corresponding to the current power class. Three modes of full-power MIMO transmission capability may include: fullpower, fullpowerMode1, or fullpowerMode2. Mode0 (fullpower) may target the UEs with full-rated PAs. Using a 2-Tx PC3 non-coherent UE as an example, the UE is equipped with two 23 dBm PAs. The UE transmits UL PUSCH using 1 antenna when the indicated TPMI is {1 0} with power scaling factor s=1. This implies that the transmit power is equally split among non-zero PUSCH antenna(s) thereby enabling the UE to deliver maximum output power. Mode1 (fullpowerMode1) includes a new TPMI subset being added. For a UE supporting a non-coherent capability, a non-antenna selection TPMI is added with the same power scaling as legacy. A new codebook subset for rank=1 includes {1 0}, {0 1}, {1 1}. With precoder {1 1}, the PC3 UE can transmit with total maximum output power of 23 dBm on PUSCH. However, precoders {1 0} and {0 1} do not deliver maximum output power. Mode2 (fullpowerMode2) includes the delivery of maximum output power through TPMI reporting and antenna virtualization. With multiple SRS resources configured in a set with different number of SRS ports (up to 4 SRS resources can be configured in a set) may include using a 2 Tx non-coherent UE as an example. The basestation may configure 2 SRS resources in a set where one SRS resource is configured with 1 port and another SRS resource is configured with 2 ports. The basestation indicates SRI corresponding to 1-port SRS while scheduling a single layer transmission, and SRI corresponding to 2-port SRS while scheduling two-layer transmission. The UE may indicate full power TPMI/TPMI groups. Using as an example a 2-Tx non-coherent PC3 UE with PA architecture where one PA is 23 dBm and another 20 dBm. The UE indicates TPMI=0 (i.e. precoder {1 0}) as full-power TPMI. When the basestation indicates full-power TPMI while scheduling PUSCH, the UE assumes power scaling factor s=1; when the basestation indicates non-full-power TPMI while scheduling PUSCH, the UE assumes a power scaling mechanism. For 2Tx UE, UE can report 2 bits, bit-map on {TPMI=0, TPMI=1}. For a 4-Tx UE, to support non-coherent and partial-coherent implementations, seven TPMI groups {G0, G1, G2, G3, G4, G5, G6} may be specified. A 4-Tx non-coherent UE can report capability to indicate 2-port TMPIs using 2-bit bitmap and one of 4-port non-coherent TPMI groups from G0˜G3. A 4-Tx partial coherent UE can report capability to indicate 2-port TMPIs using 2-bit bitmap, one of 4-port non-coherent TPMI groups from G0˜G3, and one of 4-port partial-coherent TPMI groups from G0˜G6.

Since there are three modes of full-power MIMO transmission capability, there may be a need to combine the report of ΔP_{PowerClass} and the mode of full-power MIMO transmission. Because there are up to 2 or 3 bits reserved for FR1 PHR for a cell, the bits may not be enough to report ΔP_{PowerClass} and UL full power mode independently. For example, the 2-bit for ΔP_{PowerClass}, and 2-bit for UL full power mode may not be enough. For Multiple Entry PHR MAC CE, there may be up to 2-bit reserved for FR1 PHR for a cell.

This may be done through independent indication or joint indication. For independent indication, there may be a 2-bit ΔP_{PowerClass} and 1-bit UL full power mode. 1-bit may be used to indicate whether keep current mode or to change another configured mode (e.g. current mode is mode 1, configured mode is mode 0, then 1-bit to indicate one of mode 0 and mode 1). One of the three mode may be reported, while the other two of three modes can be dynamically indicated. For example, only mode 0 or 2 may be dynamically indicated. When returning to the declared PC, mode 1 will be also returned if fullpowerMode1 is configured. In another independent indication, 1-bit ΔP_{PowerClass} and 2-bit UL full power mode may include one of the three modes being indicated by 2-bit, and 1-bit ΔP_{PowerClass} indication. In another independent indication, a 1-bit ΔP_{PowerClass} and 1-bit UL full power mode may include the 1-bit ΔP_{PowerClass} indication as described above.

For a joint indication, there may be a joint RRC configured table or a predefined table for the combination of ΔP_{PowerClass} and UL full power mode. Because there could be up to nine states for the joint indication, at least one state may not be indicated. For example, as shown in Table 20, non-zero ΔP_{PowerClass} with mode 1 may not be included. For example, as shown in Table 21, a 2-bit joint indication is used.

TABLE 17
Joint indication example with 3-bits.

| 3-bit in PHR | Combination of ΔP_{PowerClass} and UL full power mode |
|---|---|
| 000 | 0 dB and mode 0 |
| 001 | 0 dB and mode 1 |
| 010 | 0 dB and mode 2 |
| 011 | 3 dB and mode 0 |
| 100 | 3 dB and mode 2 |
| 101 | 6 dB and mode 0 |
| 110 | 6 dB and mode 2 |
| 111 | reserved |

TABLE 18
Joint indication example with 2-bits.

| 3-bit in PHR | Combination of ΔP_{PowerClass} and UL full power mode |
|---|---|
| 00 | 3 dB and mode 0 |
| 01 | 3 dB and mode 2 |
| 10 | 6 dB and mode 0 |
| 11 | 6 dB and mode 2 |

In another example, based on FIG. 4C, independent indication or joint indication of ΔP_{PowerClass} and UL full power mode can be supported by an independent octet. For example, compared with FIG. 4A, a third octet is used and X bits are used to report the joint indication of ΔP_{PowerClass} and UL full power mode, wherein, X could be 1, 2, 3, 4, 5, 6, 7 or 8. Alternatively, a third octet is used and X1 bits are used to report the ΔP_{PowerClass} and X2 bits are used to report the UL full power mode, wherein, X1 or X2 could be 1, 2, 3, 4, 5, 6, 7 or 8, and X1+X2 is no larger than 8.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software-based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication comprising:
determining, by a user equipment (UE), a parameter of adjustment to maximum output power for a given power class based on a comparison of a duty cycle associated with uplink symbols; and
reporting the parameter when triggered by at least one event, wherein the at least one event comprises a first new event comprising the duty cycle being exceeded, a second new event comprising returning to a power class, or a legacy event.

2. The method of claim 1, wherein the reporting comprises a power headroom report (PHR) control element that includes a power headroom available in the UE along with the parameter.

3-4. (canceled)

5. The method of claim 2, wherein the at least one event comprises the first new event and triggers the PHR with an actual value for the parameter, the actual value comprising an absolute value; or wherein the at least one event comprises the second new event and triggers the PHR with an actual value for the parameter, the actual value comprising an absolute value; or wherein the at least one event comprises the legacy event and triggers the PHR with a reserved state for the parameter.

6. (canceled)

7. The method of claim 2, wherein after an adjustment to maximum output power for a given power class, the given power class is returned with the second new event for returning to the given power class or based on a time offset.

8. The method of claim 7, wherein the time offset is determined by one of a predefined value, a reported value and a configured value; or the time offset is determined by another timer started when the PHR is triggered by the first new event and expired.

9. The method of claim 8, wherein the given power class is returned after the time offset, or the given power class is returned based on another reporting being triggered after the time offset from the PHR triggered by the first new event.

10-12. (canceled)

13. The method of claim 1, wherein the reporting comprises a power headroom report (PHR) control element that includes a power headroom available in the UE along with the parameter and an uplink (UL) full power mode, or an independent control element comprising the parameter and an uplink (UL) full power mode.

14. The method of claim 13, wherein the parameter and the UL full power mode are reported by independent indication or a joint indication.

15. The method of claim 1, wherein the parameter is indicated by four 2-bit values comprising 0(00), 1(01), 2(10), and 3(11);
the value 0(00) is a reserved value;
the value 1(01) corresponds to the adjustment to maximum output power being 0 dB;
the value 2(10) corresponds to the adjustment to maximum output power being 3 dB; and
the value 3(11) corresponds to the adjustment to maximum output power being 6 dB.

16-18. (canceled)

19. The method of claim 1, wherein the at least one event comprises the first new event when a configured or default duty cycle is at least partially exceeded.

20-22. (canceled)

23. A user equipment (UE) apparatus comprising:
a memory to store instructions; and
at least one processor to execute the instructions and cause the UE apparatus to:
determine a parameter of adjustment to maximum output power for a given power class based on a comparison of a duty cycle associated with uplink symbols; and
report the parameter when triggered by at least one event, wherein the at least one event comprises a first new event comprising the duty cycle being exceeded, a second new event comprising returning to a power class, or a legacy event.

24. The UE apparatus of claim 23, wherein the UE apparatus reports the parameter comprising a power headroom report (PHR) control element that includes a power headroom available in the UE along with the parameter.

25. The UE apparatus of claim 24, wherein the at least one event comprises the first new event and triggers the PHR with an actual value for the parameter, the actual value comprising an absolute value; or wherein the at least one event comprises the second new event and triggers the PHR with an actual value for the parameter, the actual value comprising an absolute value; or wherein the at least one event comprises the legacy event and triggers the PHR with a reserved state for the parameter.

26. The UE apparatus of claim 24, wherein after an adjustment to maximum output power for a given power class, the given power class is returned with the second new event for returning to the given power class or based on a time offset.

27. The UE apparatus of claim 23, wherein the parameter is indicated by four 2-bit values comprising 0(00), 1(01), 2(10), and 3(11);
the value 0(00) is a reserved value;
the value 1(01) corresponds to the adjustment to maximum output power being 0 dB;
the value 2(10) corresponds to the adjustment to maximum output power being 3 dB; and
the value 3(11) corresponds to the adjustment to maximum output power being 6 dB.

28. A base station (BS) apparatus comprising:
a memory to store instructions; and
at least one processor to execute the instructions and cause the BS apparatus to:
receive a parameter of adjustment to maximum output power for a given power class based on a comparison of a duty cycle associated with uplink symbols, wherein the parameter is received when triggered by at least one event; and wherein the at least one event comprises a first new event comprising the duty cycle being exceeded, a second new event comprising returning to a power class, or a legacy event.

29. The BS apparatus of claim 28, wherein the BS apparatus receives the parameter comprising a power headroom report (PHR) control element that includes a power headroom available in a UE along with the parameter.

30. The BS apparatus of claim 29, wherein the at least one event comprises the first new event and triggers the PHR with an actual value for the parameter, the actual value comprising an absolute value; or wherein the at least one event comprises the second new event and triggers the PHR with an actual value for the parameter, the actual value comprising an absolute value; or wherein the at least one event comprises the legacy event and triggers the PHR with a reserved state for the parameter.

31. The BS apparatus of claim 28, wherein after an adjustment to maximum output power for a given power class, the given power class is returned with the second new event for returning to the given power class or based on a time offset.

32. The BS apparatus of claim 28, wherein the parameter is indicated by four 2-bit values comprising 0(00), 1(01), 2(10), and 3(11);
the value 0(00) is a reserved value;
the value 1(01) corresponds to the adjustment to maximum output power being 0 dB;
the value 2(10) corresponds to the adjustment to maximum output power being 3 dB; and
the value 3(11) corresponds to the adjustment to maximum output power being 6 dB.
